(19) United States
(12) Patent Application Publication
(10) Pub. No.: US 2026/0312856 A1
(43) Pub. Date: Oct. 8, 2026

(54) METHOD AND SYSTEM FOR ADJUSTING OVERLAP RATIO BETWEEN FAST FOURIER TRANSFORM (FFT) BLOCKS

(71) Applicant: CIENA CORPORATION, Hanover, MD (US)

(72) Inventors: Reza Nikjah, Calgary (CA); Shahab Oveis Gharan, Ottawa (CA); Trong Tung Nguyen, Kanata (CA)

(73) Assignee: CIENA CORPORATION, Hanover, MD (US)

(21) Appl. No.: 19/098,080

(22) Filed: Apr. 2, 2025

(51) Int. Cl. H04L 27/26; H04B 10/61

(52) U.S. Cl. CPC H04L 27/26538; H04B 10/6161; H04L 27/26524

(57) ABSTRACT

Aspects of the subject disclosure may include, for example, obtaining FFT blocks having a first overlap ratio between the FFT blocks, processing the FFT blocks to derive an enlarged FFT block having a second overlap ratio that is greater than the first overlap ratio, and further processing a filtered version of the enlarged FFT block to derive reduced FFT blocks that have the first overlap ratio between the reduced FFT blocks. Other embodiments are disclosed.

### FIELD OF THE DISCLOSURE

The subject disclosure relates in general to signal processing, for example, in support of optical communication, and in particular to methods and systems for adjusting the overlap ratio between Fast Fourier Transform (FFT) blocks.

### BACKGROUND

In modern optical communication systems, numerous signal processing techniques are used to maintain high data transmission rates and signal integrity. Signal filtering in particular helps to combat signal distortions and noise. For instance, chromatic dispersion compensation can be performed to address large amounts of chromatic dispersion. While time-domain filtering can be used to provide the desired filtering, it generally involves computationally-intensive convolution operations. FFT engines, which transform complex, time domain convolutions into simpler FFT domain multiplications, are thus typically used in optical transceivers to significantly reduce computational cost and enhance the overall efficiency of the signal processing chain. However, FFT domain multiplication is only equivalent to time domain, circular convolution, which is different than the linear convolution which is often needed in such applications.

To resolve this issue, certain FFT overlap-and-save (OAS) and overlap-and-add (OAA) techniques have been adopted, where consecutive FFT blocks are applied over chunks of samples such that the consecutive FFT blocks have some number of overlapping samples E. Assume that the intent is to apply a time domain filter with M taps using FFT OAS or OAA, where the FFT size is N samples. Ensuring that E>=M (or simply E>=M−1) would guarantee that there is no circular convolution distortion within non-overlapping samples of the FFT. But this requires that there be a large enough overlap between consecutive FFT blocks. In particular, certain implementations of chromatic dispersion compensation require that the OAS ratio be greater than 50%, which comes at the cost of larger FFT sizes, larger datapath bus widths, and high power consumption. For instance, increasing the overlap portion (overlap ratio) E/N between consecutive FFT blocks undesirably increases power consumption as well as the area of the required signal processing circuit (e.g., the application-specific integrated circuit (ASIC)) by a ratio that is proportional to

$$\frac{N}{N - E} .$$

In an example case where the overlap ratio is 55% for N=288, E would be about 158, and so the power consumption and circuit area would be increased by a ratio that is proportional to 288/(288-158)~2.22. In other words, FFT OAS/OAA structures that provide for large enough overlap in order to support filters that have a sufficient number of taps, especially at high filtering speeds, generate an undue amount of heat and require much larger, and thus, costlier hardware. Therefore, there is a need to address such issues.

### BRIEF DESCRIPTION OF THE DRAWINGS

Reference will now be made to the accompanying drawings, which are not necessarily drawn to scale, and wherein:

FIG. 1A is a diagram of a non-limiting example of a communication network in accordance with various aspects described herein.

FIG. 1B is a block diagram of an example, non-limiting embodiment of a transmitter/modulator system in accordance with various aspects described herein.

FIG. 1C is a block diagram of an example, non-limiting embodiment of a receiver device in accordance with various aspects described herein.

FIG. 2A is a high-level block diagram illustrating an example implementation of an FFT resampler in an FFT engine, including an interpolator and a decimator, in accordance with various aspects described herein.

FIG. 2B illustrates the performance of a particular large tap filter implementation.

FIG. 2C is a high-level block diagram of an example implementation of the interpolator of FIG. 2A.

FIG. 2D is a high-level block diagram of an example implementation of the decimator of FIG. 2A.

FIG. 2E illustrates two adjacent or consecutive FFT blocks that are obtained for FFT resampling, in accordance with various aspects described herein.

FIG. 2F illustrates example interpolation filtering performed by the interpolator of FIG. 2A.

FIG. 2G illustrates a result of an example of summation performed by the interpolator of FIG. 2A.

FIG. 2H illustrates example large tap filtering performed by a large tap filter of FIG. 2A followed by decimation filtering performed by the decimator of FIG. 2A.

FIGS. 2I and 2J show the performance of an example implementation of the FFT resampler of FIG. 2A, particularly using a fixed-point design, under different operating conditions.

FIG. 2K illustrates an example phase rotation function of the interpolator of FIG. 2A, in accordance with various aspects described herein.

FIG. 2L shows impulse responses of example interpolation and decimation filters, in accordance with various aspects described herein.

FIG. 2M illustrates example interpolation processing including circuits for odd and even output samples, respectively, in accordance with various aspects described herein.

FIG. 2N shows frequency responses of example interpolation and decimation half-band filters, in accordance with various aspects described herein.

FIGS. 2O and 2P show example interpolator filter and decimator filter windows, respectively, in accordance with various aspects described herein.

FIG. 2Q is a graphical representation of normalized computational complexity of the FFT resampler of FIG. 2A for different overlap ratios between blocks when the FFT resampler is used in conjunction with a particular large tap filter implementation.

FIG. 2R depicts an illustrative embodiment of a method, or operations of an apparatus, in accordance with various aspects described herein.

### DETAILED DESCRIPTION

The subject disclosure describes, among other things, illustrative embodiments of an FFT resampler that performs frequency domain interpolation on consecutive FFT blocks that have a first overlap ratio between the blocks to create or reconstruct a larger FFT block that has a second overlap ratio greater than the first overlap ratio. The FFT resampler also employs frequency domain decimation to reduce the enlarged FFT blocks back down to smaller size blocks with the first overlap ratio between the reduced blocks. Decimation in this context may refer to an operation which reduces the number of samples or data points in a block, and in that sense can be contrasted with interpolation, which increases the number of samples or data points in a block. The FFT resampler can be used, for example, in digital signal processing for communication systems such as optical communication systems.

Performing interpolation to increase the overlap ratio supports FFT domain filtering techniques that require a larger number of taps, whereas subsequently performing decimation of filtered versions of the enlarged FTT blocks to reduce the overlap ratio supports FFT domain filtering techniques that utilize fewer taps. Embodiments of the interpolation and decimation functions have been found to decrease power consumption in an example ASIC datapath by about 30% to 40%. This advantageously enables optical communication system designs for high performance applications (e.g., 800 gigabytes per second (G)-long range (LR) applications, 800G-ze best range (ZR)/ZR+ applications, etc.) in a single chip with reduced power consumption and without compromising (or with minimal impact to) performance.

One or more aspects of the subject disclosure include a device. The device may include an FFT system configured to perform operations. The operations may include obtaining FFT blocks having a first overlap ratio between the FFT blocks. Further, the operations may include processing the FFT blocks to derive an enlarged FFT block having a second overlap ratio that is greater than the first overlap ratio. In some embodiments, the operations may include further processing a filtered version of the enlarged FFT block to derive reduced FFT blocks that have the first overlap ratio between the reduced FFT blocks (or at least another overlap ratio which is less than the second overlap ratio). The device may be implemented as a circuit such as an ASIC, electronic chip or chiplet or component thereof, or another form or collection of circuitry. As will be apparent from the description herein, an FFT block is a grouping of samples of a time-domain signal upon which FFT-based processing can be applied. The size of an FFT block is the number of samples in the grouping. Consecutive FFT blocks may be applied over chunks of samples such that there is some overlap between the consecutive FFT blocks. The overlap ratio between such consecutive FFT blocks is thus equal to the number of overlapping samples between a given pair of consecutive FFT blocks divided by the FFT block size. Stated differently, from the perspective of a second FFT block of the consecutive FFT blocks relative to a first FFT block of the consecutive FFT blocks (where the first FFT block may begin before the second FFT block), the overlap ratio is the ratio of the number of samples in the second FFT block that overlap with samples in the first FFT block of the consecutive FFT blocks to the total number of samples in the second FFT block. In the aforementioned operations, the processing of the FFT blocks may be performed by an interpolator, and may include upsampling and interpolation filtering. The upsampling may be performed on consecutive FFT blocks, where, for instance, in one clock cycle, a first FFT block and a second FFT block may be individually upsampled, in a next clock cycle, the second FFT block and a third FFT block may be individually upsampled, and so on. Upsampling of a given FFT block may increase the sample rate by effectively repeating the samples of the FFT block such that the FFT block is repeated fully or partially in the time domain. For instance, the size of the FFT block may double in the case of upsampling by a factor of two. The upsampled consecutive (and now enlarged) FFT blocks may be combined in a summer, the output of which may be subjected to interpolation filtering to arrive at an enlarged FFT block. In essence, the processing (interpolation) creates enlarged FFT blocks (e.g., two times, three times, etc. as large as the original FFT blocks). By virtue of the FFT block size being enlarged, without at the same time increasing the number of non-overlapping samples (i.e., “fresh data” samples), from the perspective of the enlarged FFT block, the overlap ratio—i.e., the ratio of the number of samples in the enlarged FFT block that overlap with samples in the first FFT block to the total number of samples in the enlarged FFT block excluding duplicate samples—is greater than the original overlap ratio between the smaller consecutive FFT blocks, which advantageously facilitates any subsequent large tap filtering that might be needed.

One or more aspects of the subject disclosure include a method. The method may include obtaining, by a processing system including at least one processor (e.g., a circuit), FFT blocks having a first overlap ratio between the FFT blocks. The method may also include processing, by the processing system, the FFT blocks to derive an enlarged FFT block having a second overlap ratio that is greater than the first overlap ratio.

One or more aspects of the subject disclosure include a non-transitory machine-readable medium, comprising executable instructions that, when executed by a processing system including a processor, facilitate performance of operations. The operations may include obtaining FFT blocks having a first overlap ratio between the FFT blocks. The operations may further include processing the FFT blocks to derive an enlarged FFT block having a second overlap ratio that is greater than the first overlap ratio.

Other embodiments are described in the subject disclosure.

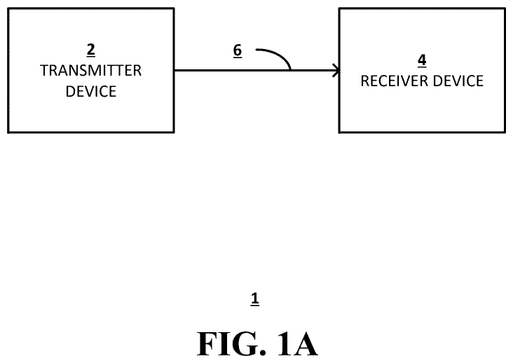

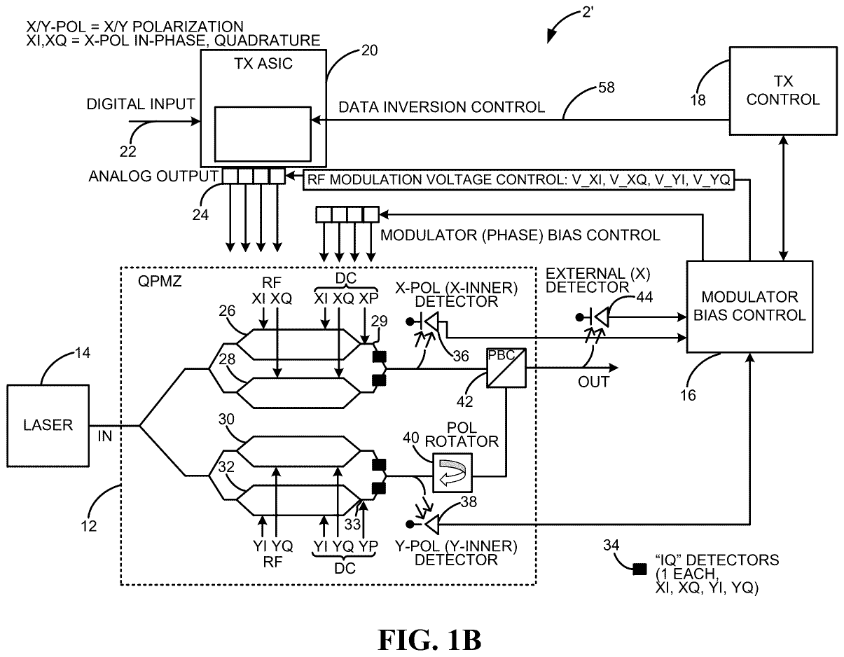

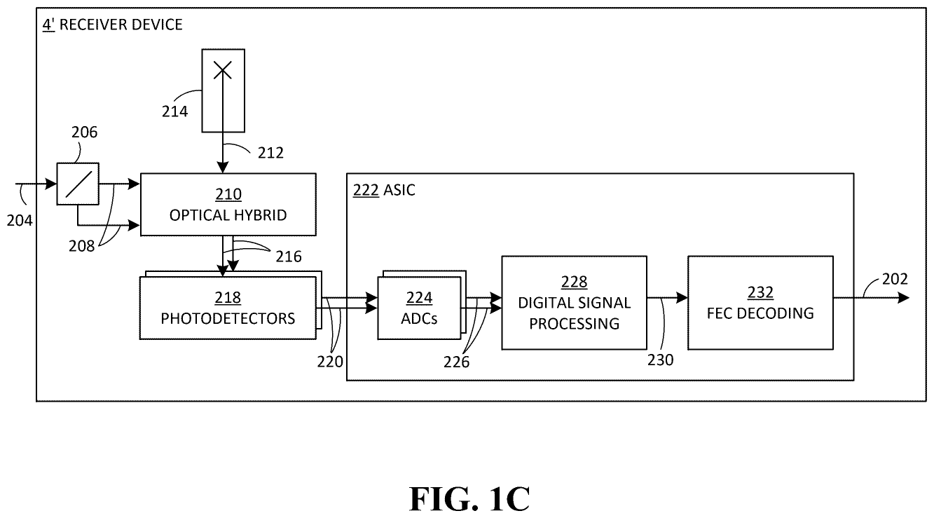

FIG. 1A is a diagram of a non-limiting example of a communication network 1 in accordance with various aspects described herein. The communication network 1 may include at least one transmitter device 2 and at least one receiver device 4. The transmitter device 2 may be capable of transmitting signals over a communication channel, such as a communication channel 6. The receiver device 4 may be capable of receiving signals over a communication channel, such as the communication channel 6. In various embodiments, the transmitter device 2 may also be capable of receiving signals and/or the receiver device 4 may also be capable of transmitting signals. Thus, one or both of the transmitter device 2 and the receiver device 4 may be capable of acting as a transceiver.

The communication network 1 may include additional elements not shown in FIG. 1A. For example, the communication network 1 may include one or more additional transmitter devices, one or more additional receiver devices, and one or more other devices or elements involved in the communication of signals in the communication network 1.

In some embodiments, the signals that are transmitted and received in the communication network 1 may include optical signals and/or electrical signals. For example, the transmitter device 2 may be a first electrical-based transceiver, the receiver device 4 may be a second electrical-based transceiver, and the communication channel 6 may be an electrical communication channel (e.g., a coaxial cable, a printed circuit board (PCB) trace, or the like). For instance, the communication network 1 may include a SerDes system. As another example, the transmitter device 2 may be a first optical transceiver, the receiver device 4 may be a second optical transceiver, and the communication channel 6 may be an optical communication channel. In certain embodiments, one or both of the first optical transceiver and the second optical transceiver may be a coherent modem.

Where the communication network 1 involves the transmission of optical signals, the communication network 1 may include additional optical elements not shown in FIG. 1A, such as wavelength selective switches, optical multiplexers, optical de-multiplexers, optical filters, and/or the like. Furthermore, each optical communication channel in the communication network 1 may include one or more links, where each link may include one or more spans, and where each span may include a length of optical fiber and one or more optical amplifiers.

Various elements and effects in an optical link between two communicating devices may result in the degradation of transmitted signals. That is, optical signals received over optical links can become distorted. Particularly, these signals may suffer from polarization mode dispersion (PMD), polarization dependent loss or gain (PDL or PDG), state of polarization (SOP) rotation, amplified spontaneous emission (ASE) noise, wavelength-dependent dispersion or chromatic dispersion (CD), nonlinear noise from propagation through fiber, and/or other effects. For instance, polarization effects of a fiber link tend to rotate the transmitted polarizations such that, at the receiver, they are neither orthogonal to each other nor aligned with the polarization beam splitter of the optical hybrid. As a result, each of the received polarizations (e.g., downstream of the polarization beam splitter) may contain energy from both of the transmitted polarizations, as well as distortions due to CD, PMD, PDL, etc. These problems may be compounded for polarization-division multiplexed signals in which each transmitted polarization contains a respective data signal. The degree of signal degradation due to noise and nonlinearity may be characterized by a signal-to-noise ratio (SNR) or, alternatively, by a noise-to-signal ratio (NSR). The signals transmitted in the communications network may be representative of digital information in the form of bits or symbols. The probability that bit estimates recovered at a receiver differ from the original bits encoded at a transmitter may be characterized by the Bit Error Ratio (BER). As the noise power increases relative to the signal power, the BER may also increase.

FIG. 1B is a block diagram of an example, non-limiting embodiment of a transmitter/modulator system 2′ in accordance with various aspects described herein. In one or more embodiments, the transmitter/modulator system 2′ may correspond to the transmitter 2 of FIG. 1A. As shown in FIG. 1B, the transmitter device 2′ may include a combination of optical and electrical components, such as, for example, a modulator 12, a laser 14, a modulator bias controller 16, a transmitter (Tx) controller 18, and a Tx application specific integrated circuit (ASIC) 20. The modulator 12 may employ nested Mach-Zehnder (MZ) architecture(s)—i.e., two dual-parallel MZs (DPMZs), each with two inner MZs and one outer MZ—resulting in a quad parallel MZ (QPMZ) modulator.

In one or more embodiments, the optical modulator system 2′ may be equipped to control four quadrature data signals (e.g., radio frequency (RF) XI, RF XQ, RF YI, RF YQ signals, where X, Y denote polarization and I, Q denote in-phase and quadrature, respectively) via the Tx ASIC 20. The modulator 12 may include an XI modulator 26, an XQ modulator 28, and an outer phase modulator 29 (respectively functioning as two inner MZs nested within an outer MZ for the X polarization) as well as a YI modulator 30, a YQ modulator 32, and an outer phase modulator 33 (respectively functioning as two inner MZs nested within an outer MZ for the Y polarization). Each MZ may have one or two DC electrodes depending on the implementation of the MZ. The laser 14 may provide a laser output for modulation by the modulator 12. The laser output may be divided (e.g., via a beam splitter) into X and Y polarizations, where the X polarization may be further divided (e.g., via another beam splitter) into an optical I input that is fed into an X-pol I-arm (i.e., the XI modulator 26) and an optical Q input that is fed into an X-pol Q-arm (i.e., the XQ modulator 28), and where the Y polarization may be further divided (e.g., via yet another beam splitter) into an optical I input that is fed into a Y-pol I-arm (i.e., the YI modulator 30) and an optical Q input that is fed into a Y-pol Q-arm (i.e., the YQ modulator 32). The modulator 12 may be capable of independently generating orthogonal optical electric field components (I channel and Q channel) for each polarization X and Y, according to various types of multi-value modulation methods, such as N-quadrature amplitude modulation (QAM), differential quadrature phase shift keying (D-QPSK), etc.

In general operation, the Tx ASIC 20 may receive a digital information stream at a digital input 22 and convert the digital information stream (based on an associated modulation scheme) for driving the modulator 12 via analog outputs 24 (RF XI, RF XQ, RF YI, RF YQ). The analog outputs 24 may be communicatively coupled to the modulator 12. In some embodiments, the Tx ASIC 20 may include a digital filter that provides a transfer function H on the received digital input 22. A digital-to-analog (D/A) converter may be connected to an output of the digital filter, and an analog amplifier may be connected to an output of the D/A converter to provide a gain G. An output of the analog amplifier may provide the analog output 24 to the modulator 12. In certain embodiments, a controller may be connected to the digital filter and the analog amplifier to control the transfer function H and/or the gain G responsive to a data inversion control signal 58 from the Tx controller 18.

A detector 34 (also referred to as a tap-detector) may be included at an output of each of the modulators 26, 28, 30, 32. In certain embodiments, some or all of the modulators 26, 28, 30, 32 may be referred to as inner modulators and can be amplitude, phase, or mixed phase/amplitude modulators. In one or more embodiments, some or all of the modulators 26, 28, 30, 32 may be phase modulators. As shown, the modulator 12 may include an X-polarization detector 36 that is coupled to a combined output of the modulators 26, 28 (or the output of the outer MZ 29), and a Y-polarization detector 38 that is coupled to a combined output of the modulators 30, 32 (or the output of the outer MZ 33). A polarization rotator 40 may be connected to the combined output of the modulators 30, 32. A polarization beam combiner 42 may be connected to the combined output of the modulators 26, 28 and the combined output of the modulators 30, 32. An output of the polarization beam combiner 42 may provide a modulated output of the modulator 12, and an external detector 44 may be tapped off of the output. The various detectors 34, 36, 38, 44 may be communicatively coupled to the modulator bias controller 16.

As shown in FIG. 1B, several modulator bias points of the modulator 12 may be controlled or optimized via the modulator bias controller 16. In some embodiments, the Tx controller 18 may control the Tx ASIC 20 and/or the modulator bias controller 16. In various embodiments, the Tx controller 18 may control the modulator bias controller 16 in the following ways: (i) open loop control where bias control loops can be opened, enabling direct control of biases and measurement of the detectors 34, 36, 38, 44; and/or (ii) closed loop control where the feedback polarity of the modulator bias controller 16 can be set, but where the modulator bias controller 16 itself implements the feedback control. The Tx controller 18 may identify (e.g., optimum) bias points whereas the modulator bias controller 16 may maintain those points in service. In some embodiments, the modulator bias controller 16 may control the generated analog output signals of the Tx ASIC 20, rather than control bias values of the modulator 12.

FIG. 1C is a block diagram of an example, non-limiting embodiment of a receiver device 4′ in accordance with various aspects described herein. In one or more embodiments, the receiver device 4′ may correspond to the receiver 4 of FIG. 1A. In various embodiments, the receiver device 4′ may be configured to receive an optical signal 204, which may comprise a degraded version of an optical signal generated by a transmitter device (e.g., the transmitter device 2′ of FIG. 1B). The optical signal generated by the transmitter device may be representative of information bits (also referred to as client bits) which are to be communicated to the receiver device 4′. The optical signal generated by the transmitter device may be representative of a stream of symbols. According to some examples, the transmitter device may be configured to apply forward error correction (FEC) encoding to the client bits to generate FEC-encoded bits, which may then be mapped to one or more streams of data symbols. The optical signal transmitted by the transmitter device may be generated using any of a variety of techniques, such as frequency division multiplexing (FDM), polarization-division multiplexing (PDM), single polarization modulation, modulation of an unpolarized carrier, mode-division multiplexing, spatial-division multiplexing, Stokes-space modulation, polarization balanced modulation, wavelength division multiplexing (WDM) (where a plurality of data streams is transmitted in parallel, over a respective plurality of carriers, and where each carrier is generated by a different laser), and/or the like.

The receiver device 4′ may be configured to recover corrected client bits 202 from the received optical signal 204. The receiver device 4′ may include a polarizing beam splitter 206 configured to split the received optical signal 204 into polarized components 208. According to one example implementation, the polarized components 208 may include orthogonally polarized components corresponding to an X polarization and a Y polarization. An optical hybrid 210 may be configured to process the components 208 with respect to an optical signal 212 produced by a laser 214, thereby resulting in optical signals 216. Photodetectors 218 may be configured to convert the optical signals 216 output by the optical hybrid 210 to analog electrical signals 220. The frequency difference between the Rx laser and the Tx laser is the Intermediate Frequency, and an offset of that away from nominal can be called fIF. (The nominal difference is usually zero.) According to one example implementation, the analog electrical signals 220 may include four signals corresponding, respectively, to the dimensions XI, XQ, YI, and YQ, where XI and XQ denote the in-phase and quadrature components of the X polarization, and YI and YQ denote the in phase and quadrature components of the Y polarization. Together, elements such as the beam splitter 206, the laser 214, the optical hybrid 210, and the photodetectors 218 may form a communication interface configured to receive optical signals from other devices in a communication network.

As shown in FIG. 1C, the receiver device 4′ may include an ASIC 222. The ASIC 222 may include analog-to-digital converters (ADCs) 224 that are configured to sample the analog electrical signals 220 and generate respective digital signals 226. In certain alternate embodiments, the ADCs 224 or portions thereof may be separate from the ASIC 222. The ADCs 224 may sample the analog electrical signals 220 periodically at a sample rate that is based on a signal received from a voltage-controlled oscillator (VCO) at the receiver device 4′ (not shown). The ASIC 222 may be configured to apply digital signal processing to the digital signals 226 using a digital signal processing system 228. The digital signal processing system 228 may be configured to perform equalization processing that is designed to compensate for a variety of channel impairments, such as CD, SOP rotation, mean PMD that determines the probability distribution which instantiates as differential group delay (DGD), PDL or PDG, and/or other effects. The digital signal processing system 228 may further be configured to perform carrier recovery processing, which may include calculating an estimate of carrier frequency offset fIF (i.e., the difference between the frequency of the transmitter laser and the frequency of the receiver laser 214). According to some example implementations, the digital signal processing system 228 may further be configured to perform operations such as multiple-input-multiple-output (MIMO) filtering, clock recovery, and FDM subcarrier de-multiplexing. The digital signal processing system 228 may also be configured to perform symbol-to-bit demapping (or decoding) using a decision circuit, such that signals 230 output by the digital signal processing system 228 are representative of bit estimates. Where the received optical signal 204 is representative of symbols comprising FEC-encoded bits generated as a result of applying FEC encoding to client bits, the signals 230 may further undergo FEC decoding 232 to recover the corrected client bits 202.

According to some example implementations, the equalization processing implemented as part of the digital signal processing system 228 may include one or more equalizers, some or all of which may be configured to compensate for impairments in the channel response. In general, an equalizer applies a substantially linear filter to an input signal to generate an output signal that is less degraded than the input signal. The filter may be characterized by compensation coefficients which may be incrementally updated from time to time (e.g., every so many clock cycles or every so many seconds) with the goal of reducing the degradation observed in the output signal.

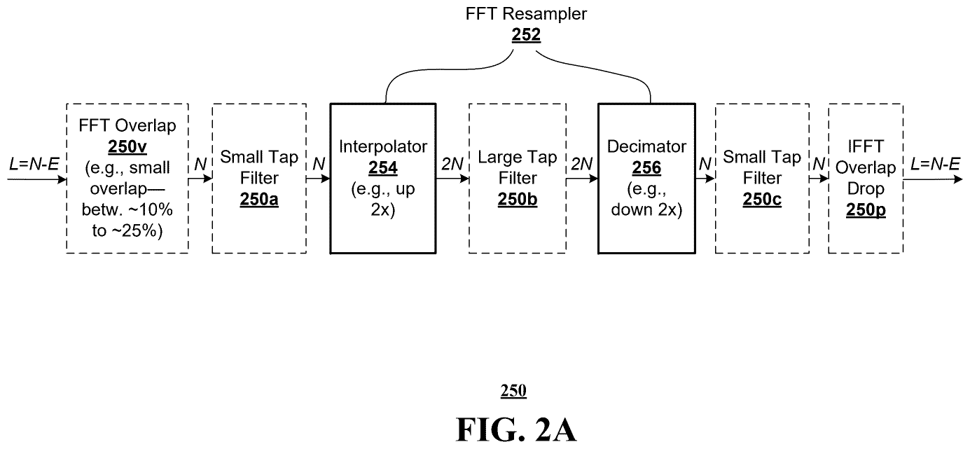

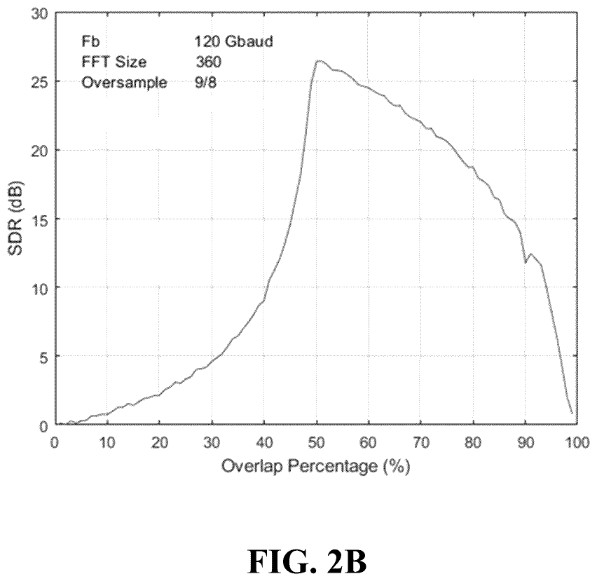

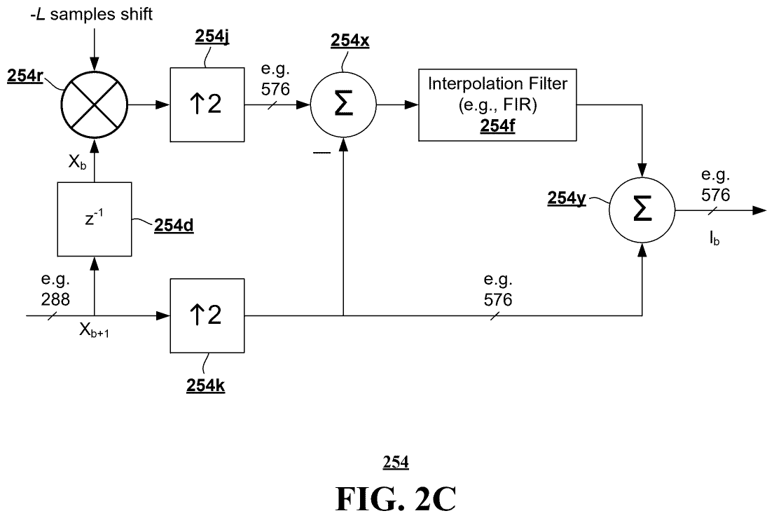

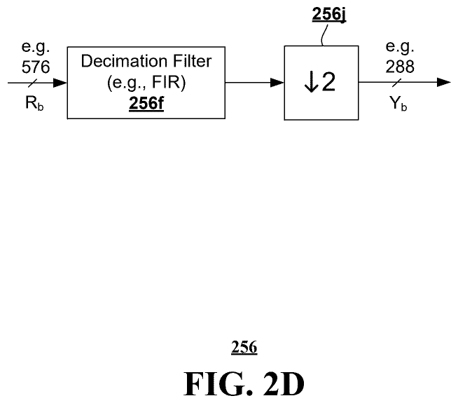

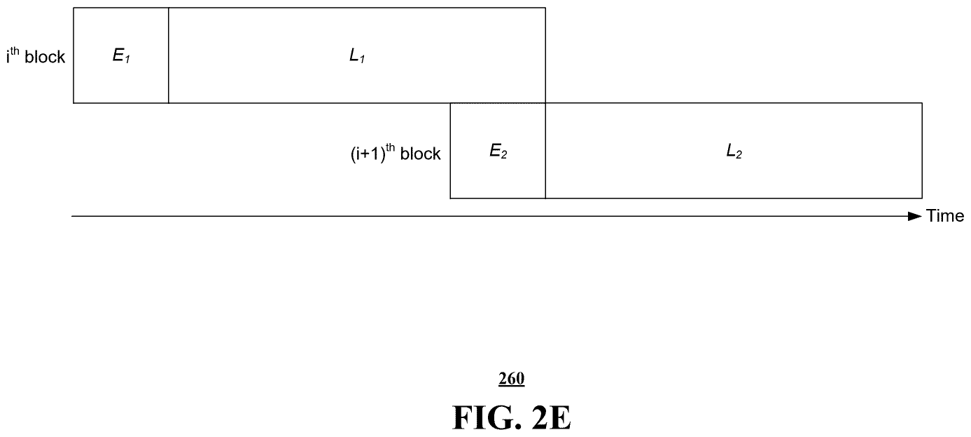

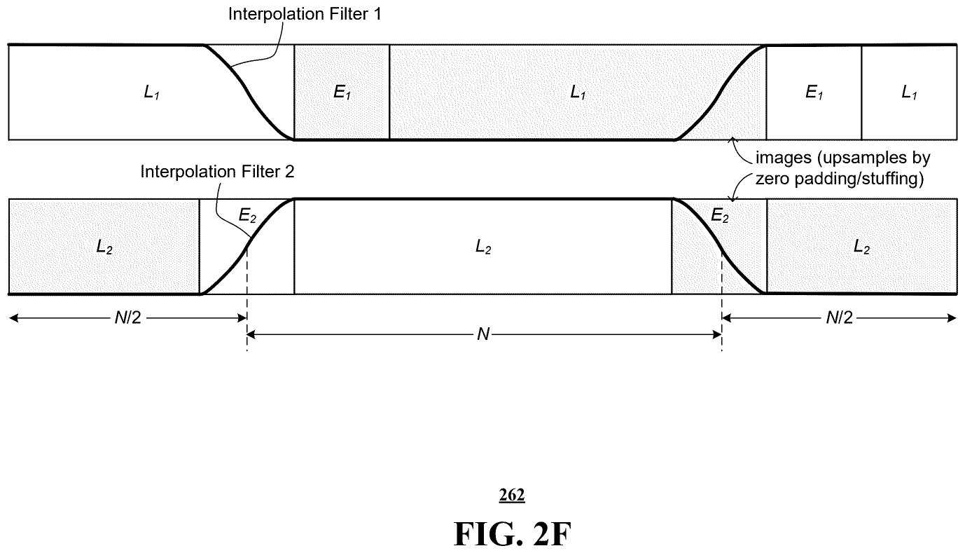

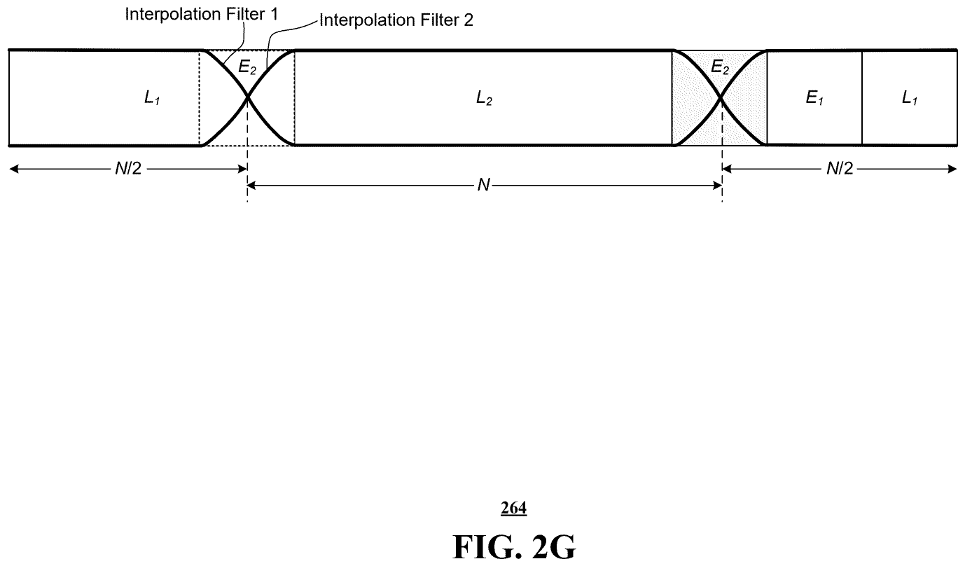

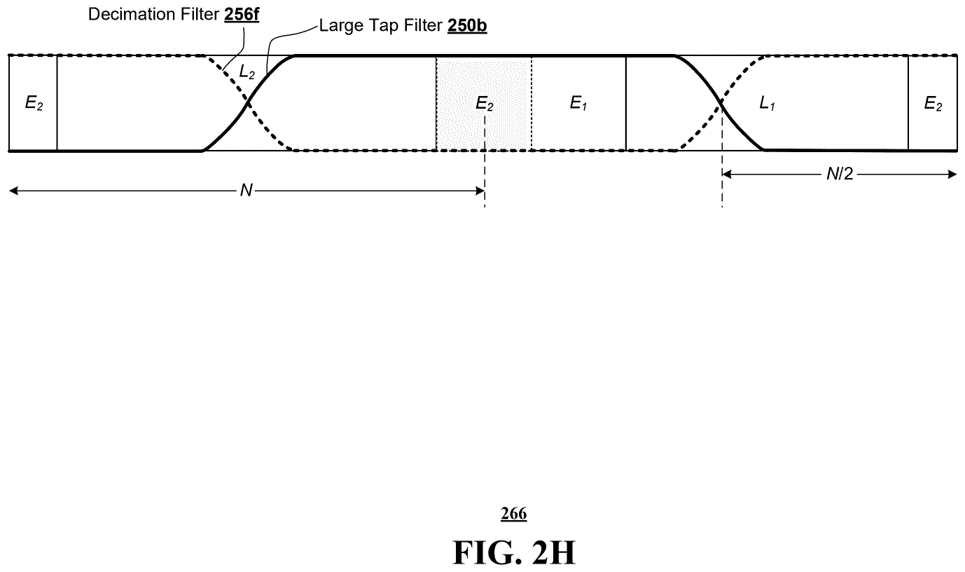

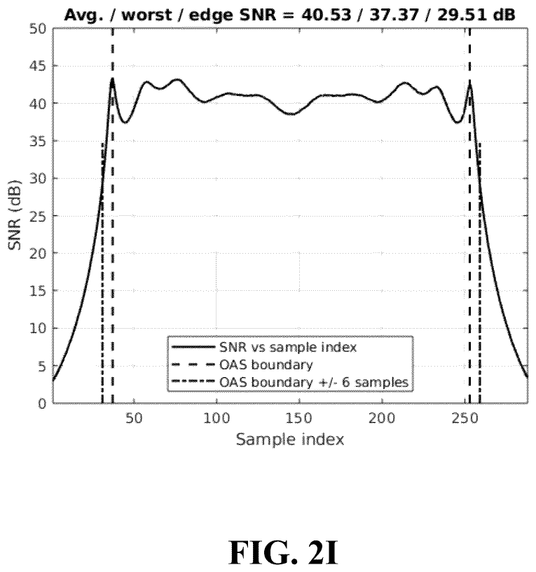

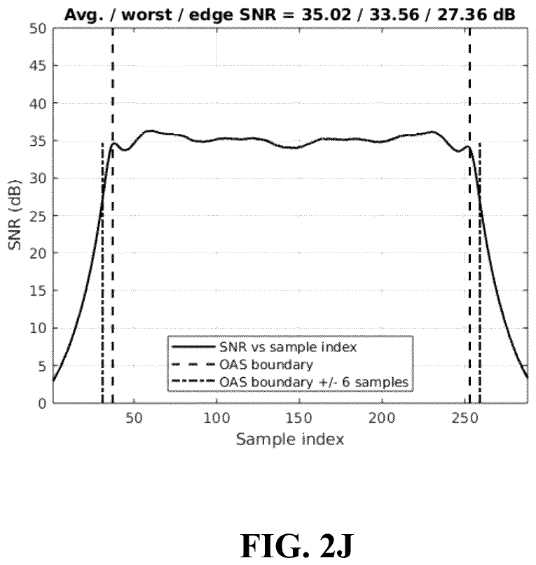

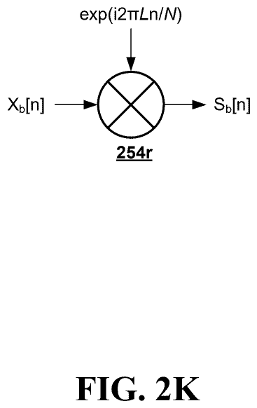

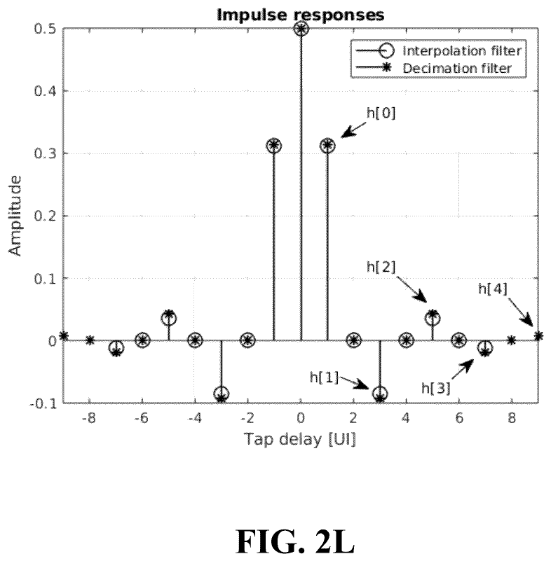

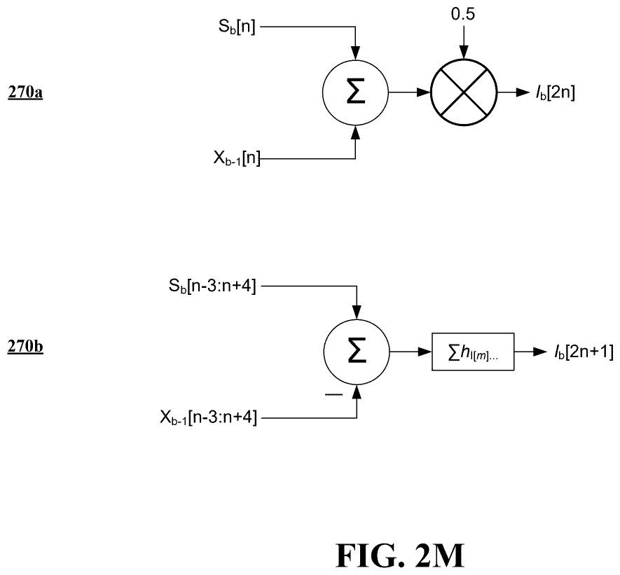

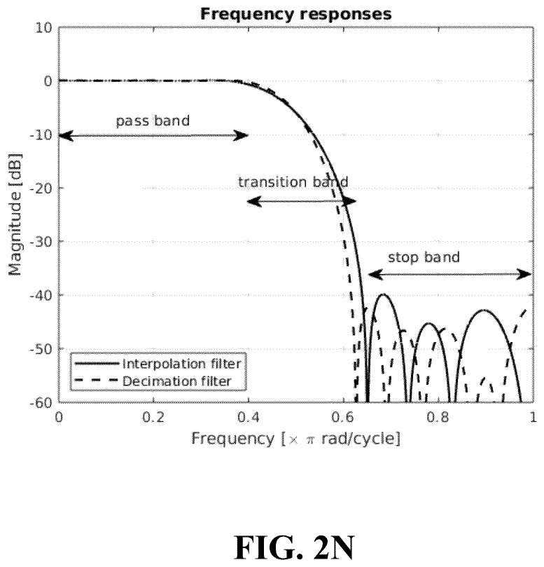

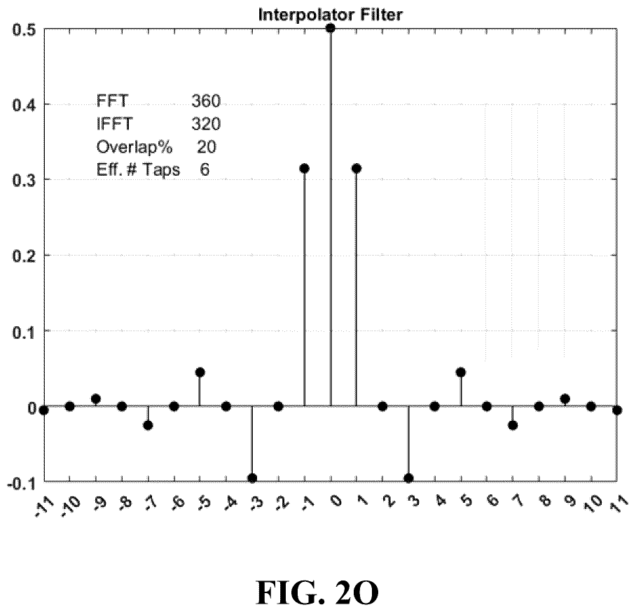

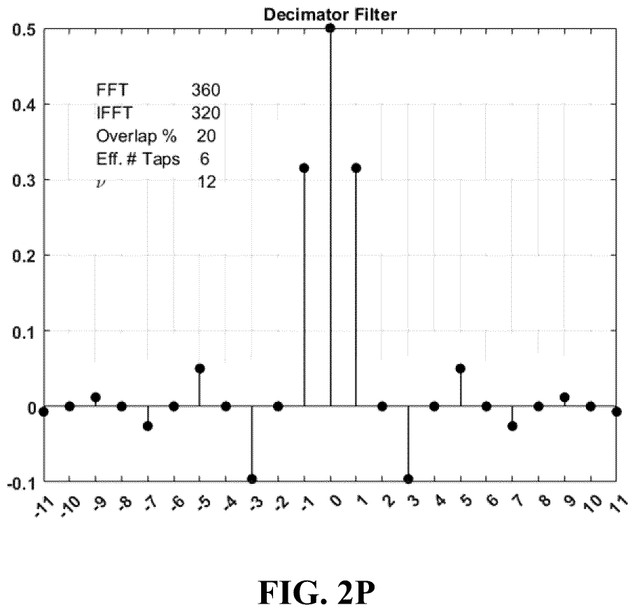

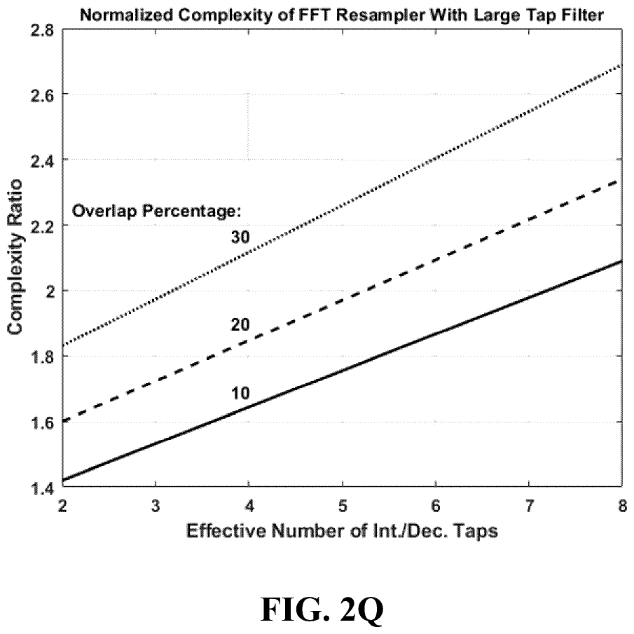

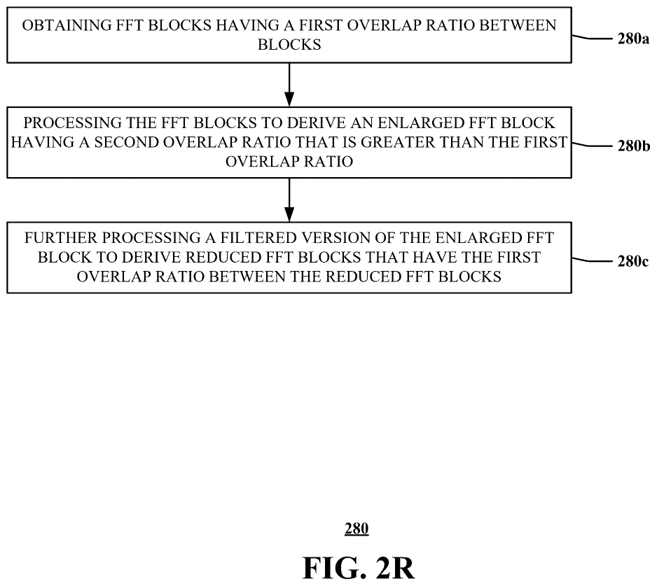

FIG. 2A is a high-level block diagram 250 illustrating an example implementation of an FFT resampler 252 in an FFT engine or system 250, in accordance with various aspects described herein. In one or more embodiments, the FFT engine 250 may be implemented in a digital signal processing chain or circuit in the receiver 4 of FIG. 1A or the receiver 4′ of FIG. 1C (e.g., within DSP 228).

The FFT engine 250 may fetch in L=N−E new, non-overlapping samples and may apply an FFT of size N thereto. The samples may be generated by the receiver's ADC(s) or may be derived from samples that are generated by the receiver's ADC(s). The FFT engine 250 may include an FFT overlap system 250v that creates FFT blocks from the fetched samples such that adjacent ones of these FFT blocks include overlapping portions. Farther downstream, the FFT engine 250 may also include an Inverse FFT (IFFT) overlap drop system 250p that removes overlapping portions from processed FFT blocks such that (e.g., only) valid, non-redundant portions are retained for further processing. The FFT overlap system 250v and the IFFT overlap drop system 250p may operate based on a (e.g., small) number of overlap samples, E. Note that an FFT block is thus a block of samples within a time-domain window whose length is equivalent to the FFT size, i.e., N described here, where the time-domain windows overlap by E samples. By way of example, the FFT engine 250 may operate with respect to a first FFT block and a second FFT block, each having N samples, and such that (e.g., the last) E samples of the first block are the same as (e.g., the first) E samples (overlap samples) of the second block.

The FFT resampler 252 may include an interpolator 254 and a decimator 256. As described in more detail below, the interpolator 254 may increase the sample rate by upsampling in the frequency domain and filtering in the frequency domain. Further, the decimator 256 may reduce the sample rate by filtering and downsampling in the frequency domain.

The FFT engine 250 may include small tap filters 250a and 250c that each includes or requires a small number of taps (i.e., fewer than E=N-L), as well as a large tap filter 250b that includes or requires a large number of taps, such as N or more taps. The small tap filters 250a and 250c may each be implemented outside of the FFT resampling zone, whereas the large tap filter 250b may be implemented in the resampling zone (after interpolation and before decimation) in order to benefit from a larger number of overlap samples, e.g., E′=N. Examples of the small tap filter 250a include those that compensate for receiver electro-optical (EO) chain response and mismatches. Examples of the small tap filter 250c include those that perform dynamic retiming, sampling clock phase recovery, and/or adaptive filter compensation for optical channel dynamic linear distortions, such as PMD, PDL, and/or SOP rotations. Examples of the large tap filter 250b include those that compensate for chromatic dispersion, which typically require a large number of taps. For example, an optical signal with a bandwidth of 120 gigahertz (GHz) and that is transmitted in the C-band through an optical fiber having 20 nanoseconds (ns) per nanometer (nm) of chromatic dispersion, might require a large tap filter that has greater than 2000 taps to fully equalize the signal.

In some implementations of the large tap filter 250b, input FFT blocks may be shifted by a “fresh data size” of L, where the impulse response of the large tap filter 250b may be partitioned into M subfilters of length L for a filter bank operation on the input signal. To avoid circular convolution noise, L may need to be ≤E+1, where E=N−L is the overlap size, and where N is the FFT size. An overlap ratio that is ≥50-50/N generally allows the large tap filter 250b to provide suitable performance. FIG. 2B illustrates the performance of a particular large tap filter implementation. As discussed below, embodiments of the FFT resampler 252 advantageously reduce power consumption and heat dissipation.

The interpolator 254 may include an FFT domain interpolation function that creates FFT blocks of size 2N based on, or from, adjacent or consecutive, original FFT blocks of size N. The decimator 256 may include an FFT domain decimation function that drops the FFT block size back to the original size N.

The interpolation may result in a doubling of the FFT size, which increases or improves the overlap ratio to

$$\frac{N}{2 N - E} = \frac{N}{N + L}$$

from the original overlap ratio of

$$\frac{N - L}{N} = E / N$$

(i.e., provided by the FFT overlap system 250v). Notably, although the FFT block size is doubled to 2N due to the interpolation, the number of overlap samples E′ is more than doubled, to N, and this contrast improves the overlap ratio. This advantageously allows for the original overlap ratio to be set much lower than conventionally possible—e.g., to about 10% or about 25%—thereby enabling reduced power consumption and heat dissipation for most of the processing chain in the FFT engine 250, such as the small tap filtering provided by the small tap filters 250a and 250c. The increased overlap ratio provided by the interpolator 254 allows for the suitable operation of the large tap filter 250b.

FIG. 2C is a high-level block diagram of an example implementation of the interpolator 254 of FIG. 2A. The interpolator 254 may include upsamplers 254j and 254k in respective paths. The path with the upsampler 254j may include a delay 254d and a sample shifter 254r. A summer 254x may sum the outputs of the upsamplers 254j and 254k and provide the summed output to an interpolation filter 254f. In exemplary embodiments, the interpolation filter 254f may be a finite impulse response (FIR) filter. A summer 254y may sum the filtered output with the output of the upsampler 254k.

FIG. 2D is a high-level block diagram of an example implementation of the decimator 256 of FIG. 2A. The decimator 256 may include a decimation filter 256f whose filtered output is provided to a downsampler 256j. In exemplary embodiments, the decimation filter 256f may be an FIR filter.

The following is a brief description of an example resampling process performed by the interpolator 254 and the decimator 256. The process may involve stitching or combining of two adjacent FFT blocks together in the frequency domain to achieve an increased OAS ratio (or overlap ratio)—i.e., a new_oas_ratio=1/(2-old_oas_ratio)—that is greater than 50%. To elaborate on this mathematical relationship, notice that the number of OAS samples is E prior to interpolation and is N after interpolation. It follows that old_oas_ratio is equal to E/N and new_oas_ratio is equal to N/(2N−E), where −E is due to the discarding of a duplicate of an overlapping portion (e.g., E₂ in the example shown in FIG. 2E) after interpolation. It thus follows that new_oas_ratio=1/(2-old_oas_ratio). In any case, the adjustment enables suitable signal processing by the large tap filter 250b. FIG. 2E illustrates an example 260 of stitching of two adjacent or consecutive FFT blocks. Here, for the sake of illustration, assuming that N=288 is the size of the FFT and that 0.25 is the old_oas_ratio, then E=288×0.25=72 is the number OAS samples, and L=N−E=216 is the number of “fresh” data samples every clock cycle.

FIG. 2F illustrates an example 262 of interpolation filtering performed by the interpolator 254 of FIG. 2A. The interpolator 254 may perform upsampling by a factor of 2 (upsampler 254j) followed by interpolation filtering (interpolation filter 254f). While upsampling and downsampling by a factor of 2 (corresponding to two consecutive FFT blocks) are described in this example implementation, it will be understood and appreciated that other factors are possible—e.g., 3, 4, etc. or even fractional factors such as 1.1, 1.2, 1.5, 2.1, 2.2, etc. (if other numbers or fractional numbers of consecutive FFT blocks are alternatively obtained), albeit at increased complexity. For instance, in certain implementations, interpolation by a factor of 3 may be performed, followed by decimation by a factor of 2, resulting at a fractional interpolation factor of 1.5. It is thus to be understood and appreciated that the OAS ratio may be adjusted by any desired amount in any part of the digital signaling processing—e.g., while interpolation may increase the OAS ratio from a first OAS ratio to a second OAS ratio, decimation can be implemented to decrease the OAS ratio from the second OAS ratio, but not necessarily down to the first OAS ratio. That is, decimation can be implemented to decrease the OAS ratio to any another OAS ratio that is less than the second OAS ratio, such as some OAS ratio that is less than the first OAS ratio or between the first OAS ratio and the second OAS ratio. In certain embodiments, a “multi-OAS” implementation can also be provided in which the OAS ratio is adjusted at different points in the digital signal processing, depending on the filtering needs.

In exemplary embodiments, the interpolation filter 254f may be a single FIR filter that includes two filtering components. In one or more embodiments, one or more (e.g., each) of these filtering components may be a Raised Cosine filter with an upsample factor of 2 and a roll-off factor that is equal to the OAS ratio. The half-band nature of these filtering components allows them to complement one another, which enables the overall interpolation to be performed using a single FIR filter instead of two or more. Of course, multiple FIR filters may alternatively be utilized if desired. To ensure real coefficients for the FIR filter, the input data block may be cyclically shifted by L/2 samples—e.g., immediately after the OAS processing by the FFT overlap system 250v. The two adjacent FFT blocks may be delayed with respect to one another such that they are L samples apart (delay 254d, sample shifter 254r). Because the L/2 samples shift is applied prior to FFT processing, the two adjacent FFT blocks will have corresponding cyclical shifts of −L/2 and +L/2 samples, as compared to the original signal. The L-samples delay in the time domain is equivalent to a phase shift in the frequency domain (FIG. 2C):

$${S}_{b} [ f ] = {X}_{b} [ f ] \cdot exp ( - i 2 π Lf )$$

Summation by way of the summer 254y may result in an FFT block size of 2N, with L fresh data samples and N overlapped samples. FIG. 2G illustrates a result 264 of an example summation performed by the interpolator 254 of FIG. 2A. Here, E₁L₁E₂ are the “overlapped” portion of the FFT frame in the 2x upsample domain, and L₂ is the “fresh data” portion. The equalized output data is distinct from the “fresh data”. Effectively, anti-causal filtering is involved here and the chunk of equalized data that is to be kept is under the decimation filter 256f, which consists of a portion of L₁, an entirety of E₂, and a portion of L₂.

FIG. 2H illustrates an example 266 of large tap filtering performed by the large tap filter 250b of FIG. 2A followed by decimation filtering performed by the decimator 256 of FIG. 2A. In one example implementation of the large tap filter 250b, the filter may include two taps for each of 2N frequency bins of the FFT, where the causal delay/center of the filter is −N/2. In various embodiments, the decimation filter 256f may be half-band, and may be designed in a similar manner as the interpolation filter 254f.

FIGS. 21 and 2J show the performance of an example implementation of the FFT resampler 250, particularly using a fixed-point design, under different operating conditions. FIG. 2I shows the performance at 20 ns/nm of chromatic dispersion at 120 gigabaud (Gbaud). Here, the SNR was measured at each of 256 samples per frame. Over the non-OAS area, the average SNR is 40.53 decibels (dB), with a worst case SNR of 37.37 dB. At 6 samples away from the OAS boundary, the SNR is 29.51 dB, which is a sufficient margin for equalization (e.g., Least Mean Squares (LMS)) purposes. FIG. 2J shows the performance at 60 ns/nm of chromatic dispersion. Here, the average SNR is about 35 dB.

The following is a brief description of various example (e.g., hardware) implementations of the FFT resampler 252. The resampling process may begin with a phase rotation that is followed by a one sample delay that is applied on each of the frequency bins of the FFT. FIG. 2K illustrates an example phase rotation, in accordance with various aspects described herein. The phase rotation in the frequency domain is equivalent to −L samples circularly shifted in the time domain. This shifting separates or distances two adjacent FFT frames by L samples. Conveniently, with L/N=¾, there are only 4 distinct rotation angles of

$$0 , - \frac{π}{2} , π , and \frac{π}{2} ,$$

where multiplication factors are 1, −j, −1 or j. As such, no multiplication operations may be required here. It will be understood and appreciated that the phase rotation may or may not be needed, depending on the processing that occurs upstream of the FFT resampler 252. For instance, in certain embodiments, the small tap filter 250a may implement an equivalent phase rotation as part of its processing, in which case, the need for a phase rotator in the FFT resampler 252 may be obviated.

Interpolation in the resampling process may cascade multiple (e.g., two) N-point FFT frames into a single 2N-point FFT frame. Special characteristics of the FIR filtering can be taken advantage of to create an efficient design, i.e.:
real and symmetric frequency taps of the filter
every other coefficient being equal to zero
the center tap being exactly 0.5 (multiplier-less) FIG. 2L shows impulse responses of example interpolation and decimation filters, in accordance with various aspects described herein.

As one example, assume that upsampling is by a factor of 2. In this case, we interpolate X_{b}[n], n=0, 1, . . . N−1 into I_{b}[m], m=0, 1, . . . 2N−1, where the even-index samples can be obtained without the need for convolution, i.e.:

$${I}_{b} [ 2 n ] = 0.5 \cdot {X}_{b} [ n ] , n = 0 , 1 , … N - 1 ,$$

which characterizes the middle tap of the FIR filter. The odd-index samples, however, require convolution using 4 taps multiplication:

$${I}_{b} [ 2 n + 1 ] = {\sum }_{m = 0}^{3} {h}_{I} [ m ] \cdot ( {X}_{b} [ ( n - m ) mod N ] + {X}_{b} [ ( n + m + 1 ) mod N ] ) ,$$

$$n = 0 , 1 , … N - 1$$

where h_{I}[m] represents the interpolation FIR filter taps. In one example, the taps may be:

$${h}_{I} [ 0 ] = 0 \text{.3125}$$

$${h}_{I} [ 1 ] = - 0.089 \; 84375$$

$${h}_{I} [ 2 ] = 0.03 \; 90625$$

$${h}_{I} [ 3 ] = - 0.015625$$

which was found to provide about 42.2 dB of interpolation penalty.

FIG. 2M illustrates example interpolation processing including circuits 270a and 270b for odd and even output samples, respectively, in accordance with various aspects described herein. Circuit 270a may produce even-index samples via a summation operation. The scaling by 0.5 may be achieved by moving the fixed point of the result, and thus may involve no multiplication operations. Circuit 270b may produce odd-index samples, and may be configured to perform convolution in which (e.g., 8) input samples are consumed to produce a single output sample.

It will be understood and appreciated that the interpolation filtering may be implemented in any suitable manner and thus the aforementioned implementation is discussed merely as an example. For instance, in some embodiments, the length of the interpolation filter may be modified (e.g., reduced by one tap) and/or the resolution of the coefficients may be modified (e.g., reduced by 2 bits). As another example, the two interpolation filter components may be exact complements of one another (e.g., in the case of minimum mean square error (MMSE) calculation of the filter taps) or may not be. As yet another example, circuit parameters can be adjusted to arrive at requiring only a single phase rotator for the interpolation stage of the FFT resampling process, or the circuit(s) may be implemented with two phase rotators. As a further example, while the interpolation filter taps are described herein as being real and symmetric, they may instead include complex ones and/or may not be symmetric. While the filter taps are also described as being alternately equal zero, they may instead be implemented using other values in accordance with other pattern(s).

Special characteristics of the decimator's FIR filtering can be taken advantage of to create an efficient design, i.e.:
real and symmetric frequency taps of the filter
every other coefficient being equal to zero

The decimation processing may produce N samples from a 2N input according to the following equation:

$${Y}_{b} [ n ] = {( - 1 )}^{n} \cdot ( {R}_{b} [ 2 n ] + {\sum }_{m = 0}^{4} {h}_{D} [ m ] \cdot ( {R}_{b} [ 2 n + 2 m + 1 mod 2 N ] + {R}_{b} [ 2 n - 2 m - 1 mod 2 N ] ) ) ,$$

for n=0, 1, . . . . N−1. The term (−1)ⁿ circularly shifts the frame by N/2 samples, such that the overlap-and-drop operation can operate on the middle portion of the IFFT output. In one example, the taps of the decimation filter may be:

$${h}_{D} [ 0 ] = 0.3144 \; 53125$$

$${h}_{D} [ 1 ] = - 0.0917 \; 96875$$

$${h}_{D} [ 2 ] = 0.042 \; 96875$$

$${h}_{D} [ 3 ] = - 0 \text{.0625}$$

$${h}_{D} [ 4 ] = - 0.01953125$$

which was found to provide about 43.8 dB of decimation distortion penalty.

It will be understood and appreciated that the decimation filtering may be implemented in any suitable manner and thus the aforementioned implementation is discussed merely as an example. For instance, in some embodiments, the resolution of the coefficients may be modified (e.g., reduced by 2 bits). As another example, while the decimation filter taps are described herein as being real and symmetric, they may instead include complex ones and/or may not be symmetric. While the filter taps are also described as being alternately equal zero, they may instead be implemented using other values in accordance with other pattern(s).

The following is a brief description of the derivation of desired (or optimal) truncated FIR filtering for the above-described resampling process—i.e., optimization of the filtering factors for two parameters:
the number of one-sided filter taps that are not 0 or 0.5
the target filter roll-off

It is to be noted that each half-band filter:
has no distortion in the transition band for up/down sampling
has the same distortion in the passband versus the stopband—in fact, the distortion in the passband and stopband mirror one another

FIG. 2N shows frequency responses of example interpolation and decimation half-band filters, in accordance with various aspects described herein. Optimization of the FIR filters can focus on reducing or minimizing the passband distortion. This is a linear problem, where we can denote:
h as an M×1 vector of filter coefficients that need to be optimized—i.e., M=4 for the interpolation filter 254f and 5 for the decimation filter 256f.
T as an N×1 vector of the target passband response. N can be a large number (i.e., 1024) for higher resolution of the passband. While T should be a vector of all 1s, it can instead be a vector of all entries being 0.5 if the FIR center tap is excluded from the optimization problem.
F as an N×M matrix of Fourier transform that converts the filter coefficients into the passband response. Since the filter is symmetrical, F becomes a Cosine transform matrix:

$$F ( n , m ) = 2 \cdot cos ( \frac{- 2 π ( 2 m + 1 ) ( 1 - α ) n}{4 N} ) , n = 0 , 1 , … N - 1$$

where α is the target roll-off of the filter. For the interpolation filter 254f, there are always E overlapping samples output from the OAS process, and thus

$${α}_{intp} = \frac{E}{N} = 0.25$$

For the decimation filter 256f, it might be desirable to reserve some samples outside of the OAS region as margin for equalization to compensate for DGD, PMD, etc. Assume that ν=6 samples are reserved on each side of the OAS region. In such case, the target roll-off of the decimation filter 256f would be:

$${α}_{dec} = \frac{E - 2 v}{N} = 0.2083$$

The decimation filter solution thus reduces or minimizes the distortion that occurred in the middle L+2ν samples out of N samples of the frame. The linear equation can then be solved to obtain the optimal filter coefficients:

$$h = F \backslash T$$

As an example, where α=0.25 and M=4, the optimal interpolation filter has a Raised Cosine shape with a roll-off factor=0.3025. In this case, distortion was measured as 42.9 dB for an example system. Note that the forward slash \ denotes a linear algebra problem—i.e., T=F*h. In a case where the matrix F is a square matrix and invertible, then the linear equation is equivalent to h=F−1*T, which is a unique solution. On the other hand, in a case where matrix F is not a square matrix or not invertible, then many solutions (rather than a unique solution) may exist for h. Solving the linear algebra problem may involve identifying just one solution that satisfies the linear equation, even if many solutions may exist.

FIGS. 2O and 2P show example interpolator filter and decimator filter windows, respectively, in accordance with various aspects described herein. As illustrated, the filters may have real and symmetric taps, where every other tap may be equal to zero.

FIG. 2Q is a graphical representation of normalized computational complexity of the FFT resampler 252 for different overlap ratios between blocks when the resampler is used in conjunction with a particular large tap filter implementation. The complexity ratio is calculated as follows:

$$\frac{{( 2.2 \times \# FixedMult + 9.7 \times \# VarMult + \# Add )}_{Resamp le}}{{( 2.2 \times \# FixedMult + 9.7 \times \# VarMult + \# Add )}_{Conventional}}$$

where Resample=Resample circuit with a 2-tap version of the large tap filter, and Conventional=Conventional 50% overlap using that 2-tap version of the large tap filter. #FixedMult, #VarMult, #Add represent the total number of fixed multiplications (when one operand is fixed and known), variable multiplications (when operands are variable), and additions needed, respectively, to implement the corresponding circuit. Note that the formula above for the relative complexity is not general, but is based on 9-bit operands and 14 nm ASIC technology, as an example. As illustrated in the graph, more filter taps increases the complexity (since more computational resources are required). The curves for overlap ratios of 30%, 20%, and 10% are generally straight lines and thus there is a linear relationship between the number of taps and the complexity ratio.

It is to be understood and appreciated that, although one or more of FIGS. 1A to 2R might be described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein. Furthermore, while various components, devices, systems, modules, circuits, etc. may have been illustrated in one or more of FIGS. 1A to 2Q as separate components, devices, systems, modules, circuits, etc., it will be appreciated that multiple components, devices, systems, modules, circuits, etc. can be implemented as a single component, device, system, module, circuit, etc., or a single component, device, system, module, circuit, etc. can be implemented as multiple components, devices, systems, modules, circuits, etc. Additionally, functions described as being performed by one component, device, system, module, circuit, etc. may be performed by multiple components, devices, systems, modules, circuits, etc., or functions described as being performed by multiple components, devices, systems, modules, circuits, etc. may be performed by a single component, device, system, module, circuit, etc.

FIG. 2R depicts an illustrative embodiment of a method 280, or corresponding operations of an apparatus, in accordance with various aspects described herein.

At 280a, the method can include obtaining FFT blocks having a first overlap ratio between blocks. For example, the FFT resampler 252 may, similar to that described above with respect to one or more of FIGS. 2A to 2Q, perform one or more operations that include obtaining FFT blocks having a first overlap ratio between blocks.

At 280b, the method can include processing the FFT blocks to derive an enlarged FFT block having a second overlap ratio that is greater than the first overlap ratio. For example, the FFT resampler 252 may, similar to that described above with respect to one or more of FIGS. 2A to 2Q, perform one or more operations that include processing the FFT blocks to derive an enlarged FFT block having a second overlap ratio that is greater than the first overlap ratio.

At 280c, the method can include further processing a filtered version of the enlarged FFT block to derive reduced FFT blocks that have the first overlap ratio between the reduced FFT blocks. For example, the FFT resampler 252 may, similar to that described above with respect to one or more of FIGS. 2A to 2Q, perform one or more operations that include further processing a filtered version of the enlarged FFT block to derive reduced FFT blocks that have the first overlap ratio between the reduced FFT blocks.

While for purposes of simplicity of explanation, the respective processes are shown and described as a series of blocks in FIG. 2R, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In various embodiments, threshold(s) may be utilized as part of determining/identifying one or more actions to be taken or engaged. The threshold(s) may be adaptive based on an occurrence of one or more events or satisfaction of one or more conditions (or, analogously, in an absence of an occurrence of one or more events or in an absence of satisfaction of one or more conditions).

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized. It is also to be understood and appreciated that the subject matter in one or more dependent claims may be combined with that in one or more other dependent claims.

What is claimed is:

1. A device, comprising:
a Fast Fourier Transform (FFT) system configured to perform operations that include
obtaining FFT blocks having a first overlap ratio between the FFT blocks, and
processing the FFT blocks to derive an enlarged FFT block having a second overlap ratio that is greater than the first overlap ratio.

2. The device of claim 1, wherein the FFT blocks comprise two FFT blocks, wherein the first overlap ratio relates to a number of samples in a second one of the two FFT blocks that overlap with samples in a first one of the two FFT blocks relative to a total number of samples in the second FFT block, and wherein the second overlap ratio relates to a number of samples in the enlarged FFT block that overlap with samples in the first one of the two FFT blocks relative to a total number of samples in the enlarged FFT block excluding duplicate samples.

3. The device of claim 1, wherein the processing involves upsampling at least two of the FFT blocks.

4. The device of claim 3, wherein the upsampling is performed with an upsample factor of at least two.

5. The device of claim 1, wherein the processing involves interpolation filtering of upsampled versions of the FFT blocks.

6. The device of claim 5, wherein the interpolation filtering is performed using a finite impulse response (FIR) filter.

7. The device of claim 5, wherein the interpolation filtering is performed using complementary interpolation filters, and wherein one or more of the complementary interpolation filters is a half-band filter, is symmetrical, has real coefficients, or a combination thereof.

8. The device of claim 5, wherein the interpolation filtering is performed using one or more raised cosine filters.

9. The device of claim 1, wherein the second overlap ratio facilitates certain subsequent filtering of the enlarged FFT block.

10. The device of claim 9, wherein the certain subsequent filtering comprises chromatic dispersion compensation.

11. The device of claim 1, wherein the operations further include processing a filtered version of the enlarged FFT block to derive reduced FFT blocks having the first overlap ratio between the reduced FFT blocks.

12. The device of claim 11, wherein the processing the filtered versions involves decimation filtering.

13. The device of claim 11, wherein the processing the filtered versions involves downsampling.

14. The device of claim 1, wherein the device comprises a coherent optical receiver.

15. The device of claim 1, wherein the FFT blocks have the first overlap ratio based on overlap-and-save (OAS) processing.

16. A method, comprising:
obtaining, by a processing system including at least one processor, Fast Fourier Transform (FFT) blocks having a first overlap ratio between the FFT blocks; and
processing, by the processing system, the FFT blocks to derive an enlarged FFT block having a second overlap ratio that is greater than the first overlap ratio.

17. The method of claim 16, wherein the processing involves upsampling at least two of the FFT blocks.

18. The method of claim 16, wherein the processing involves interpolation filtering of upsampled versions of the FFT blocks.

19. The method of claim 16, further comprising processing a filtered version of the enlarged FFT block to derive reduced FFT blocks having the first overlap ratio between the reduced FFT blocks or another overlap ratio that is less than the second overlap ratio.

20. A non-transitory machine-readable medium, comprising executable instructions that, when executed by a processing system including a processor, facilitate performance of operations, the operations comprising:
obtaining Fast Fourier Transform (FFT) blocks having a first overlap ratio between the FFT blocks; and
processing the FFT blocks to derive an enlarged FFT block having a second overlap ratio that is greater than the first overlap ratio.
